(19) United States
(12) Patent Application Publication
(10) Pub. No.: US 2023/0083271 A1
(43) Pub. Date: Mar. 16, 2023

(54) INSPECTION DEVICE, METHOD OF DETERMINING NON-INSPECTION-TARGET AREA, AND STORAGE MEDIUM

(71) Applicant: Kengo Yamamoto, Kanagawa (JP)

(72) Inventor: Kengo Yamamoto, Kanagawa (JP)

(73) Assignee: Ricoh Company, Ltd., Tokyo (JP)

(21) Appl. No.: 17/816,506

(22) Filed: Aug. 1, 2022

(30) Foreign Application Priority Data
Sep. 13, 2021 (JP) 2021-148644

(51) Int. Cl. G06T 7/00; G06T 7/73; H04N 1/00

(52) U.S. Cl. CPC G06T 7/0004; G06T 7/73; H04N 1/00005; G06T 2207/30144; G06T 2207/30204

(57) ABSTRACT

An inspection device includes processing circuitry. The processing circuitry searches for a mark included in master image data generated based on an image to be printed. The processing circuitry determine a non-inspection-target area to be excluded from an inspection-target area in a conveyance medium on which the image is printed, based on a position of the searched mark.

### CROSS-REFERENCE TO RELATED APPLICATION

This patent application is based on and claims priority pursuant to 35 U.S.C. § 119(a) to Japanese Patent Application No. 2021-148644, filed on Sep. 13, 2021, in the Japan Patent Office, the entire disclosure of which is hereby incorporated by reference herein.

### BACKGROUND

### Technical Field

Embodiments of the present disclosure relate to an inspection device, a method of determining a non-inspection-target area, and a storage medium.

### Related Art

Generally, production printing is demanded to determine whether a print output of a printer is in an abnormal state. In order to meet such demand, an inspection device is known to read the print output of the printer with a camera or a line sensor of a scanner and inspect whether printing is correctly performed based on a result of reading the print output.

In a typical inspection device, an inspection target may be a sheet assumed to be cut and a print job assuming the cutting of the sheet. In this case, a cut area of the sheet is finally unused. Accordingly, when inspection is constantly performed on the entire surface of the sheet, the sheet may be undesirably determined to be defective due to an abnormality in the cut area even though no abnormality is present in an image area. In order to avoid this inconvenience, techniques have been proposed and already known that a user sets any area of the sheet as a non-inspection-target area not inspected by an inspection device so that the inspection is not performed in the non-inspection-target area.

### SUMMARY

Embodiments of the present disclosure described herein provide a novel inspection device including processing circuitry. The processing circuitry searches for a mark included in master image data generated based on an image to be printed. The processing circuitry determine a non-inspection-target area to be excluded from an inspection-target area in a conveyance medium on which the image is printed, based on a position of the searched mark.

Embodiments of the present disclosure described herein provide a novel computer-executable method of determining a non-inspection-target area. The method includes searching and determining. The searching searches for a mark included in master image data generated based on an image to be printed. The determining determines a non-inspection-target area to be excluded from an inspection-target area in a conveyance medium on which the image is printed, based on a position of the searched mark.

Embodiments of the present disclosure described herein provide a novel non-transitory, computer-readable storage medium storing computer-readable program code that causes a computer to perform searching and determining. The searching searches for a mark included in master image data generated based on an image to be printed. The determining determines a non-inspection-target area to be excluded from an inspection-target area in a conveyance medium on which the image is printed, based on a position of the searched mark.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a system configuration of an image forming system according to embodiments of the present disclosure;

FIG. 2 is a diagram illustrating a hardware configuration of a printer of the image forming system of FIG. 1;

FIG. 3 is a diagram illustrating a hardware configuration of an inspection device of the image forming system of FIG. 1;

FIG. 4 is a diagram illustrating a functional configuration of the printer of the image forming system of FIG. 1;

FIG. 5 is a diagram illustrating a functional configuration of the inspection device of the image forming apparatus of FIG. 1;

FIG. 6 is a flowchart of an example of a defect detection process according to embodiments of the present disclosure;

FIG. 7 is a flowchart of an example of a mark searching process according to embodiments of the present disclosure;

FIG. 8 is a diagram illustrating an example of a mark according to embodiments of the present disclosure;

FIG. 9 is a diagram illustrating another example of the mark according to embodiments of the present disclosure;

FIG. 10 is a diagram illustrating a mark searching method according to embodiments of the present disclosure;

FIG. 11 is a diagram illustrating a determination method of a non-inspection-target area according to embodiments of the present disclosure; and

FIG. 12 is a diagram illustrating an example of a setting screen according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Descriptions are given of an image forming system according to embodiments of the present disclosure, with reference to the drawings.

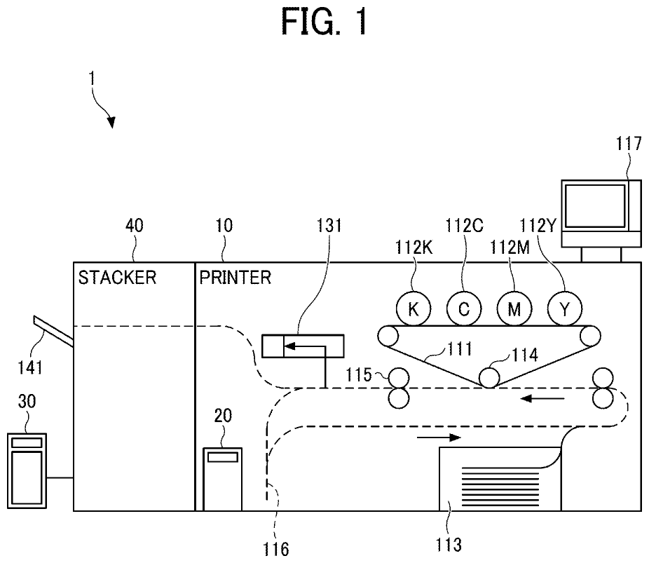

FIG. 1 is a diagram illustrating a system configuration of the image forming system according to embodiments of the present disclosure.

An image forming system 1 includes a printer 10, an inspection device 20, a digital front end (DFE) 30, and a stacker 40. These devices are communicably connected to each other via a communication line or a communication network.

The printer 10 receives print job data including user image data from an external device such as the DFE 30. Then, the printer 10 executes printing in response to receipt of an execution instruction based on the received print job data or the user operation on an operation panel 117 of the printer 10.

The printer 10 includes photoconductor drums 112Y, 112M, 112C, and 112K disposed along a conveyance belt 111. The photoconductor drums 112Y, 112M, 112C, and 112K form yellow (Y), magenta (M), cyan (C), and black (K) toner images, respectively. The conveyance belt 111 is a moving unit of an endless loop.

Specifically, the printer 10 includes the photoconductor drums 112Y, 112M, 112C, and 112K disposed in this order from upstream in a traveling direction of the conveyance belt 111. The conveyance belt 111 is an intermediate transfer belt on which an intermediate transfer image to be transferred onto a sheet fed from a sheet feeding tray 113 along the conveyance belt 111 is formed.

The printer 10 transfers respective images of black (K), cyan (C), magenta (M), and yellow (Y), which are developed with toner on respective surfaces of the photoconductor drums 112 for the four colors, onto the conveyance belt 111 in a superimposing manner to form a full-color image. Then, the printer 10 transfers the full-color image formed on the conveyance belt 111 onto the sheet that has been conveyed by a transfer roller 114 along a sheet conveyance passage, at a position at which the full color image comes closest to the sheet conveyance passage indicated with broken lines in FIG. 1. Accordingly, the full color image is formed on the sheet.

The printer 10 further conveys the sheet having the image on the surface, so that the image is fixed to the sheet by a fixing roller pair 115. Then, the sheet is conveyed to a reading device 131 disposed downstream from the fixing roller pair 115 in a conveyance direction of the sheet. The reading device 131 reads the sheet conveyed via the fixing roller pair 115 and generates read image data. Further, the reading device 131 may acquire a read image after the full color toner image is fixed to the sheet by the fixing roller pair 115. Alternatively, the reading device 131 may acquire a read image before the sheet enters the fixing roller pair 115 after the full color image is transferred by the transfer roller 114.

In the case of single-side printing, the printer 10 directly ejects the sheet read by the reading device 131 to the stacker 40. In the case of duplex printing, the printer 10 reverses the sheet read by the reading device 131, in a sheet reverse passage 116, and then conveys the sheet to a transfer position of the transfer roller 114 again.

Subsequently, the printer 10 transfers and fixes a toner image to the opposite side of the sheet having the printed image on one side. Then, the reading device 131 reads the printed surface. Subsequently, the printer 10 ejects the duplex printed sheet to the stacker 40.

The stacker 40 stacks and stores sheets ejected from the printer 10 on a sheet ejection tray 141.

The inspection device 20 is a device that inspects printed sheets output from the printer 10. Specifically, the inspection device 20 generates a master image based on rasterized image data received from the printer 10. Then, the inspection device 20 compares the read image read by the reading device 131 with the master image and determines whether the read image includes any defect. The operation panel 117 acquires information indicating an inspection result from the inspection device 20 and displays the information. The rasterized image is, for example, in the CMYK format (format in a subtractive color mode including cyan, magenta, yellow, and black) with 8-bit colors and 600 dpi resolution. The read image is, for example, in the red, green, and blue (RGB) format with 8-bit colors and 200 dpi resolution.

The DFE 30 receives and manages print job data from a terminal operated by a user. The print job data includes image data and print job information indicating attributes of the job such as the number of copies to be printed, the number of pages to be printed, duplex or single-side printing, and the type of sheet. The DFE 30 adds the received print job data as a queue to a memory that stores the print job data. The DFE 30 extracts the print job data from the queue in the order in which the print job data is added to the queue or in accordance with a priority set appropriately. Then, the DFE 30 transmits the print job data to the printer 10.

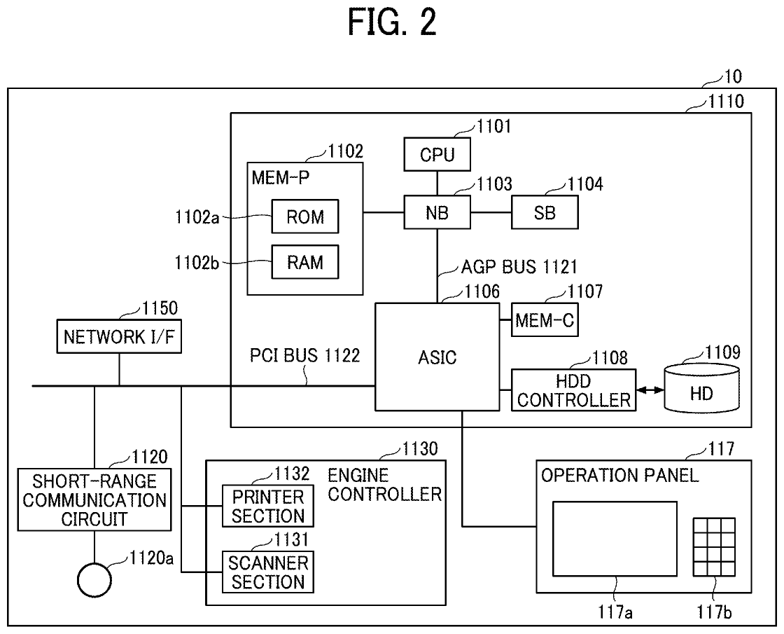

FIG. 2 is a diagram illustrating a hardware configuration of the printer 10.

The printer 10 includes a controller 1110, a short-range communication circuit 1120, an engine controller 1130, the operation panel 117, and a network interface (I/F) 1150.

The controller 1110 includes a central processing unit (CPU) 1101 that is a main part of a computer, a system memory (MEM-P) 1102, a north bridge (NB) 1103, a south bridge (SB) 1104, an application specific integrated circuit (ASIC) 1106, a local memory (MEM-C) 1107 that is a memory device, a hard disk drive (HDD) controller 1108, and a hard disk (HD) 1109 that is a memory device.

The NB 1103 and the ASIC 1106 are connected with an accelerated graphics port (AGP) bus 1121.

The CPU 1101 is a control device that performs overall control of the printer 10. The NB 1103 is a bridge to connect the CPU 1101, the MEM-P 1102, the SB 1104, and the AGP bus 1121. The NB 1103 includes a memory controller that controls reading from and writing to the MEM-P 1102, a peripheral component interconnect (PCI) master, and an AGP target.

The MEM-P 1102 includes a read only memory (ROM) 1102a and a random access memory (RAM) 1102b. The ROM 1102a is a memory to store programs and data for implementing various functions of the controller 1110. The RAM 1102b is a memory to deploy programs, data or to render print data for memory printing. The program stored in the RAM 1102b may be provided as a file in an installable format or an executable format that the program is recorded in a computer-readable storage medium such as a compact disc-read only memory (CD-ROM), a compact disc-recordable (CD-R), or a digital versatile disc (DVD).

The SB 1104 is a bridge to connect the NB 1103 to PCI devices and peripheral devices. The ASIC 1106 is an integrated circuit (IC) for image processing having a hardware element for image processing and has a role of a bridge that connects the AGP bus 1121, a PCI bus 1122, the HDD controller 1108, and the MEM-C 1107 to each other.

The ASIC 1106 includes a PCI target, an AGP master, an arbiter (ARB) serving as a core of the ASIC 1106, a memory controller that controls the MEM-C 1107, a plurality of direct memory access controllers (DMAC) that rotates image data by hardware logic, and a PCI unit that transfers data between a scanner section 1131 and a printer section 1132 via the PCI bus 1122. A universal serial bus (USB) interface or an Institute of Electrical and Electronics Engineers 1394 (IEEE 1394) interface may be connected to the ASIC 1106.

The MEM-C 1107 is a local memory used as a copy image buffer and a code buffer. The HD 1109 is a memory device that stores image data, font data used in printing, and forms. The HD 1109 controls reading or writing of data from or to the HD 1109 under the control of the CPU 1101.

The AGP bus 1121 is a bus interface for a graphics accelerator card that has been proposed to speed up graphics processing. The AGP bus 1121 is a bus that allows direct access to the MEM-P 1102 at high throughput to speed up the graphics accelerator card.

The short-range communication circuit 1120 includes a short-range communication antenna 1120a. The short-range communication circuit 1120 is a communication circuit that communicates in compliance with the near field radio communication (NFC) or the Bluetooth®.

The engine controller 1130 includes the scanner section 1131 and the printer section 1132. The operation panel 117 includes a panel display 117a and hard keys 117b. The panel display 117a is, e.g., a touch screen that displays current settings or a selection screen that receives a user input. The hard keys 117b include, e.g., a numeric keypad and a start key. The numeric keypad receives setting values of image forming parameters such as an image density parameter. The start key receives an instruction to start copying.

The controller 1110 controls the overall printer 10 and controls, for example, drawing, communication, and input from the operation panel 117. The scanner section 1131 reads an image formed on a conveyance medium such as a sheet and generates image data. The printer section 1132 includes a transfer device to transfer the image using a color material such as a toner image onto the conveyance medium such as the sheet, a fixing device to fix the image, a heating device, a drying device, and performs image formation on the sheet. Further, the scanner section 1131 or the printer section 1132 executes image processing such as error diffusion and gamma conversion.

Note that the sheet is an example of the conveyance medium. The conveyance medium may be any medium other than paper, such as a film sheet or a plastic sheet, as long as the conveyance medium is stacked in a sheet feeding tray provided for the printer 10, to be conveyed and output according to an output instruction of a slip sheet.

The network I/F 1150 is an interface that performs communication of data through the communication network. The short-range communication circuit 1120 and the network I/F 1150 are electrically connected to the ASIC 1106 via the PCI bus 1122.

Although the example of the printer 10 illustrated in FIG. 2 includes an electrophotographic image forming mechanism, the printer 10 may include another image forming mechanism such as an inkjet image forming mechanism.

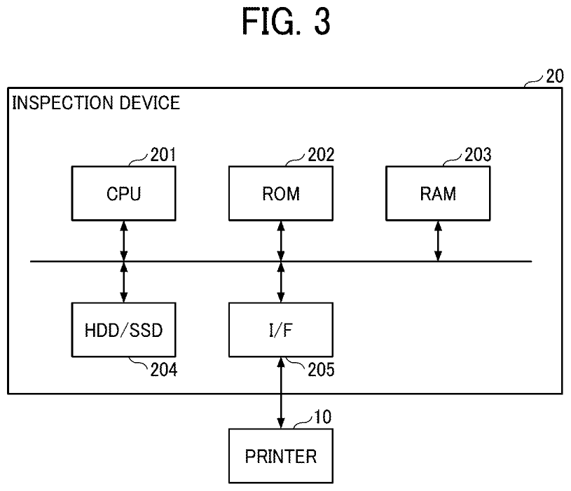

FIG. 3 is a diagram illustrating a hardware configuration of the inspection device 20.

The inspection device 20 is configured by a computer and includes a central processing unit (CPU) 201, a read only memory (ROM) 202, a random access memory (RAM) 203, a hard disk drive/solid state drive 204 (hereinafter, the HDD/SSD 204), and an interface (I/F) 205.

The CPU 201 reads programs stored in the ROM 202 or the HDD/SSD 204 and stores the programs in the RAM 203. Then, the CPU 201 executes various processes in accordance with the program stored in the RAM 203. The processes are described below.

The ROM 202 is a non-volatility auxiliary memory device. The ROM 202 stores programs such as a basic input/output system (BIOS) that define programed basic operations of the inspection device 20.

The RAM 203 is a volatile main memory device. The RAM 203 is used as a working area of the CPU 201.

The HDD/SSD 204 is a large capacity non-volatility auxiliary memory device. The HDD/SSD 204 stores received image data, programs for various processes, and setting information. The processes are described below.

The I/F 205 is, for example, a local area network (LAN) card, and is a relay unit for communicating with other devices such as the printer 10.

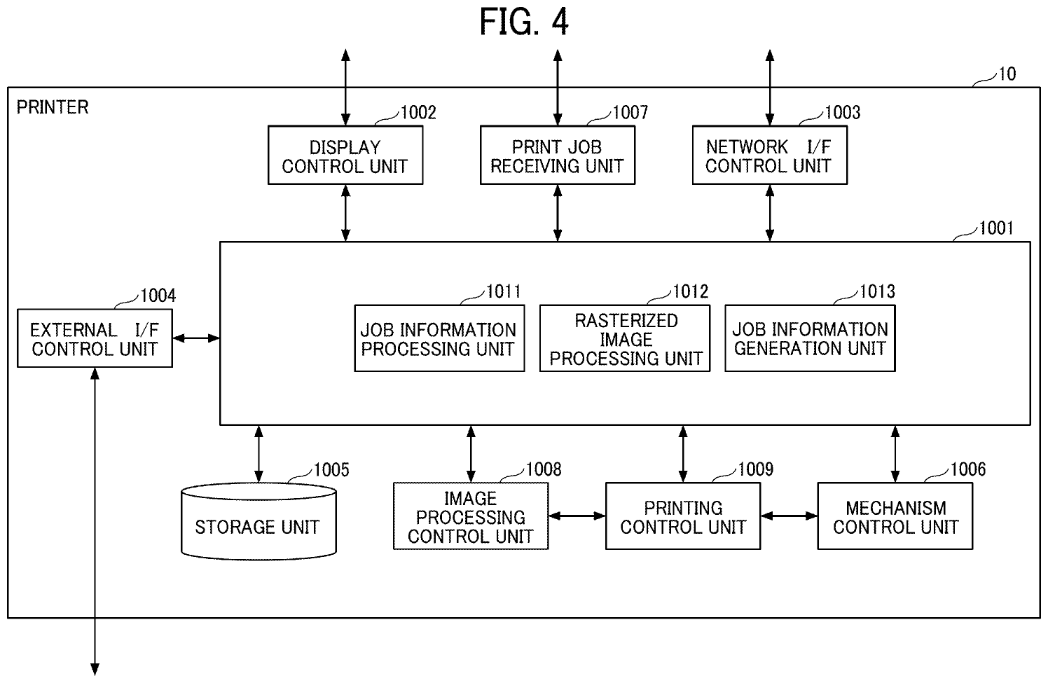

FIG. 4 is a diagram illustrating a functional configuration of the printer 10.

The printer 10 includes a system control unit 1001, a display control unit 1002, a network I/F control unit 1003, an external I/F control unit 1004, a storage unit 1005, a mechanism control unit 1006, a print job receiving unit 1007, an image processing control unit 1008, and a printing control unit 1009. Each of these units of the printer 10 is achieved by the CPU 1101 or the ASIC 1106 of the printer 10 executing a process defined in programs stored in the MEM-P 1102 or the MEM-C 1107.

The system control unit 1001 controls the overall operation of the printer 10. The system control unit 1001 includes a job information processing unit 1011, a rasterized image processing unit 1012, and a job information generation unit 1013.

The job information processing unit 1011 processes job information included in the print job data transmitted from the DFE 30. The rasterized image processing unit 1012 processes the rasterized image data included in the print job transmitted from the DFE 30. The job information generation unit 1013 generates job information for inserting a slip sheet in response to receipt of information instructing the insertion of the slip sheet from the inspection device 20.

The display control unit 1002 controls to display various types of information including job information on the operation panel 117. The network I/F control unit 1003 controls the network I/F 1150 and controls connection with the communication network. When another device is connected to the printer 10, the external I/F control unit 1004 controls connection with the connected device. The storage unit 1005 stores various types of information including job information.

The mechanism control unit 1006 controls operations of mechanisms included in the printer 10, such as operations of a mechanism that performs sheet conveyance and operations of a mechanism that performs a transfer process in the printer 10 including the printer section 1132. The print job receiving unit 1007 receives the print job data from the DFE 30. The image processing control unit 1008 processes a print image transferred by the mechanism control unit 1006. The printing control unit 1009 controls the image formation on the conveyance medium. The mechanism control unit 1006, the image processing control unit 1008, and the printing control unit 1009 cooperate with each other to function as an image forming unit that forms an image on the conveyance medium.

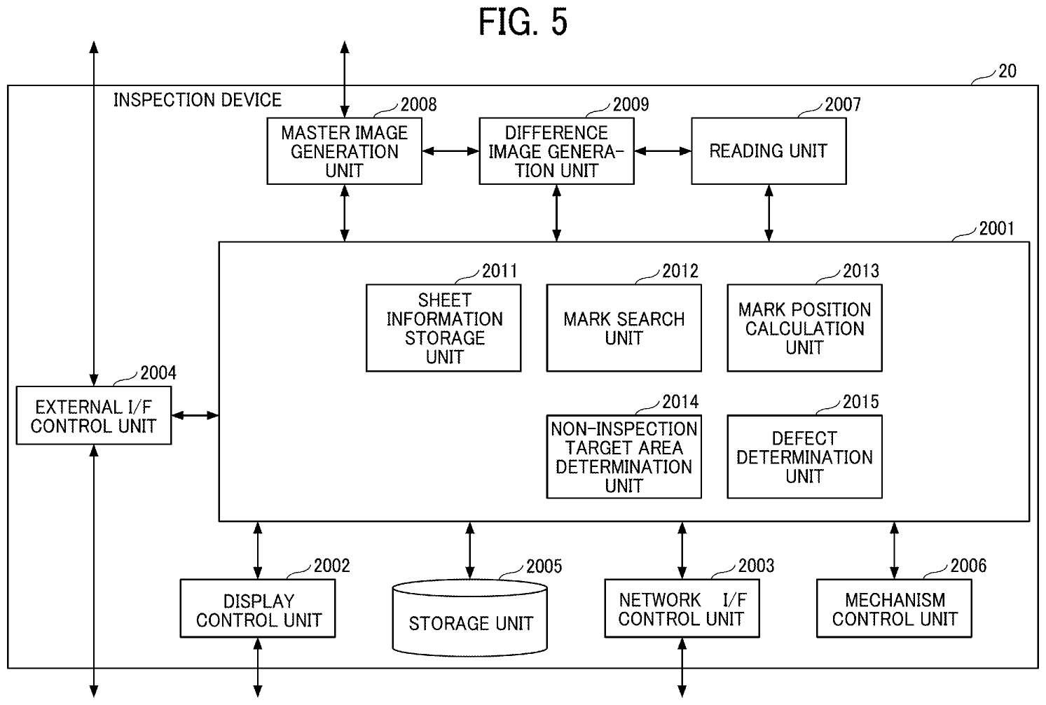

FIG. 5 is a diagram illustrating a functional configuration of the inspection device 20.

The inspection device 20 includes a system control unit 2001, a display control unit 2002, a network I/F control unit 2003, an external IT control unit 2004, a storage unit 2005, a mechanism control unit 2006, a reading unit 2007, a master image generation unit 2008, and a difference image generation unit 2009. Each of these units is achieved by the CPU 201 of the inspection device 20 executing processing defined in programs stored in the RAM 203 or the ROM 202 of the inspection device 20.

The system control unit 2001 controls the overall operation of the inspection device 20. The system control unit 2001 extracts information to be processed by a post-processing device (for example, a device that performs post-processing such as the stacker 40) from job information and transmits the extracted information to the post-processing device via the external I/F control unit 2004. In addition, the system control unit 2001 transfers the job information excluding the information to be processed by the post-processing device, to the master image generation unit 2008, the reading unit 2007, and the mechanism control unit 2006.

The system control unit 2001 includes a sheet information storage unit 2011, a mark search unit 2012, a mark position calculation unit 2013, a non-inspection-target area determination unit 2014, and a defect determination unit 2015.

The sheet information storage unit 2011 stores sheet information. The sheet information is information indicating attributes such as the size of the sheet. For example, the attributes include coordinate values indicating edges of the sheet based on the master image generated by the master image generation unit 2008.

The mark search unit 2012 searches for a mark included in the master image. The mark to be searched is, for example, a trimming mark or a corner mark for cutting. A detailed description of a mark searching method is Liven below.

The mark position calculation unit 2013 calculates the position of the mark searched by the mark search unit 2012. Specifically, the mark position calculation unit 2013 calculates the coordinate value indicating the position of the searched mark based on the sheet information such as a coordinate value indicating an edge of the sheet.

The non-inspection-target area determination unit 2014 determines an area between an end portion of the master image and the position of the mark as a non-inspection-target area. Note that the non-inspection-target area determination unit 2014 determines the non-inspection-target area for each page. As a result, the non-inspection-target area may be set to a different area for each page.

Based on a difference image generated by the difference image generation unit 2009, the defect determination unit 2015 determines whether any defect is included in a printed material, with a defect determination threshold set in advance. An inspection-target area to be inspected by the defect determination unit 2015 is set in advance. In a case where the non-inspection-target area is determined by the non-inspection-target area determination unit 2014, the defect determination unit 2015 determines whether the read image includes any defect in the inspection-target area other than the non-inspection-target area.

The display control unit 2002 controls to display various types of information including the inspection result on the operation panel 117 or a different device. Examples of the different device include terminal devices used by a user, such as a personal computer (PC) or a tablet PC, and the DFE 30. The display control unit 2002 may perform a process of returning information stored in the inspection device 20 in response to a request from software such as a web browser executed in the different device.

Further, the display control unit 2002 and software executed in the different device may transmit information of the inspection device 20 to the different device using a bidirectional communication protocol such as WebSocket and display the information in real time. For example, when software executed in the different device displays a list of defective printed sheets by accessing the inspection device 20, the list is automatically updated each time a defect occurs, and information of a defective printed sheet or information of the slip sheets is additionally displayed.

The display control unit 2002 may be included in the inspection device 20 as a web server or may be included in a cloud server that receives information of the inspection result from the inspection device 20.

The network I/F control unit 2003 controls a network with an external device. The external I/F control unit 2004 controls an interface with an external device such as the 1/F 205.

The storage unit 2005 stores various types of information. Specifically, the storage unit 2005 stores job execution history information related to the job for which the control has been ended, and a difference image data indicating the difference between the read image data and master image data.

The mechanism control unit 2006 controls an operation of a mechanism included in the inspection device 20.

The reading unit 2007 acquires the read image data from the reading device 131. The reading unit 2007 may have a function of reading an image.

The master image generation unit 2008 generates the master image data based on rasterized image data indicating an image to be printed by the printer 10. Specifically, the master image generation unit 2008 converts the rasterized image data in the CMYK format into the master image data in the RGB format.

Note that the master image data is data serving as a reference for comparison with the read image data and is used as the correct data obtained when the master image data is correctly printed. The master image data may be created by reading the sheet on which a reference image is printed with the scanner section 1131, an inline sensor, or a scanner of an external device.

The difference image generation unit 2009 generates difference image data indicating a difference in density values (RGB values) for each pixel between the master image data and the read image data.

The defect determination unit 2015 compares the difference image data with a predetermined threshold to determine whether the printed image has a defect. The threshold is information (value) serving as a criterion for determining that the printed image has the defect. The defect determination unit 2015 refers to the threshold and determines that the image has the defect if the difference image data has an area exceeding the threshold.

The threshold is, for example, a value indicating that a difference (comparison result) between density values of each pixel included in the difference image data is equal to or greater than a predetermined density value, or a value indicating the area of a portion where pixels having a difference equal to or greater than the predetermined density value are continuous. The setting of the threshold can be changed by a user so that the threshold is increased (the criterion is loosened) or decreased (the criterion is tightened).

A defect refers to a portion of image data determined to be different from an image desired by the user (for example, master image data) when a determination result determined by the defect determination unit 2015 exceeds a threshold. Examples of the defect include a spot, a streak, a positional deviation of the image, a difference in color, and a void in color.

Note that the defect determination method may be, for example, a determination method of determining whether the value of a printed image exceeds a set threshold (difference from ideal image data) based on the read image data obtained by reading ideal image data in advance of printing, as a method other than the above-described method of comparing the master image data and the read image data. Further, before the defect determination process is performed, correction processing may be performed to increase the accuracy of the determination processing. The correction processing is processing such as skew correction of the read image data for correcting the read image data of a medium conveyed in a skewed manner to a correct orientation or position, or flare correction for correcting a white light portion in the read image data at the time of reading.

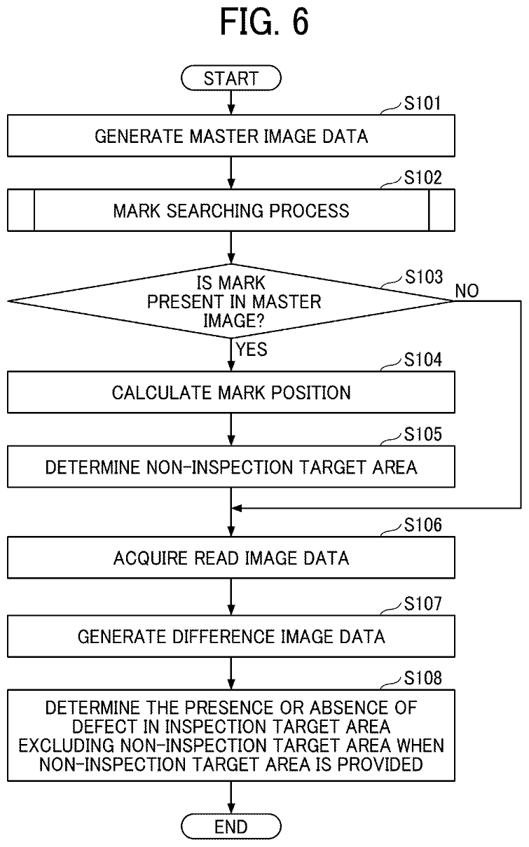

Next, descriptions are given of operations of the inspection device 20, with reference to FIG. 6. When the printer 10 performs printing on both sides of the sheet based on the print job data, the inspection device 20 executes a defect detection process.

FIG. 6 is a flowchart of an example of the defect detection process.

The following processing is executed for each page included in the print job data. The master image generation unit 2008 generates the master image data based on the rasterized image data (step S101). The mark search unit 2012 performs a mark searching process on the master image data (step S102). A detailed description of the mark searching process is given below. The mark search unit 2012 determines whether a mark is present in the master image based on a result of the mark searching process (step S103).

When the mark search unit 2012 determines that the mark is present in the master image (YES in step S103), the mark position calculation unit 2013 calculates the mark position, in other words, the coordinate value indicating the position of the searched mark based on the sheet information (step S104). Then, the non-inspection-target area determination unit 2014 determines a non-inspection-target area based on the calculated mark position (step S105). A specific example of a method of determining the non-inspection-target area is described below.

When the mark search unit 2012 determines that the mark is not present in the master image (NO in step S103), the mark search unit 2012 skips steps S104 and S105 and proceeds to step S106.

Subsequently, the reading unit 2007 acquires the read image data from the reading device 131 (step S106). The difference image generation unit 2009 generates a difference image based on the master image data and the read image data (step S107). The defect determination unit 2015 determines the presence or absence of a defect in the inspection-target area excluding the non-inspection-target area when the non-inspection-target area is determined by the non-inspection-target area determination unit 2014 (step S108).

In a case where the non-inspection-target area is not determined, the defect determination unit 2015 determines the presence or absence of a defect with respect to the entire inspection-target area. In addition, in a case where the non-inspection-target area set in advance by a user is provided, the defect determination unit 2015 may determine the presence or absence of a defect in the inspection-target area other than the set non-inspection-target area. In other words, the non-inspection-target area determination unit 2014 may execute the processing of step S105 when the user has not set the non-inspection-target area in advance.

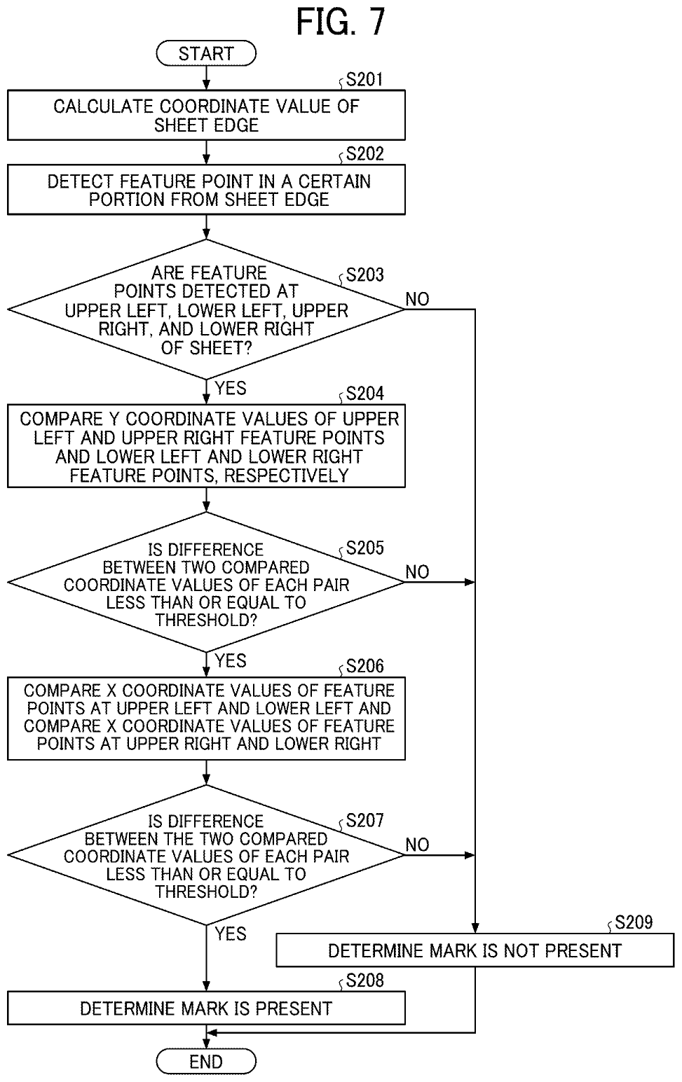

FIG. 7 is a flowchart of an example of the mark searching process.

In step S102 of the defect detection process described above, the mark search unit 2012 executes the mark searching process.

The mark search unit 2012 calculates the coordinate value of the sheet edge based on the master image data (step S201). The coordinate value is, for example, a value in a coordinate system in which an axis along the conveyance direction of the sheet is a Y axis and an axis orthogonal to the Y axis is an X axis. Specifically, the mark search unit 2012 calculates coordinate values of the upper left, lower left, upper right, and lower right edges of the sheet from the master image data. For example, the mark search unit 2012 sets a boundary position where a point that changes from the area outside the sheet toward the center of the sheet is present, and then determines the coordinate value of each edge of the sheet based on the boundary position. However, the calculation method is not limited to the method described above. Note that the coordinate values of the sheet edges may be included in the sheet information in advance. In this case, the mark search unit 2012 may skip the processing of step S201.

Next, the mark search unit 2012 detects feature points in given areas from the sheet edges (step S202). The given areas are set in advance. A detailed description of a method of detecting feature points is given below.

Next, the mark search unit 2012 determines whether the feature points are detected at the upper left, lower left, upper right, and lower right of the sheet (step S203). The mark search unit 2012 performs corner detection on the given areas from the upper left, lower left, upper right, and lower right edges of the sheet, and detects the feature points. A detailed description of the corner detection is given below.

When the mark search unit 2012 determines that the feature points are not detected at the upper left, lower left, upper right, and lower right of the sheet (NO in step S203), the mark search unit 22 determines that the mark does not exist (step S209), and then the mark searching process ends.

When the mark search unit 2012 determines that the feature points are detected at the upper left, lower left, upper right, and lower right of the sheet (YES in step S203), the mark search unit 22 compares the Y coordinate values of the feature points at the upper left and upper right and compares the Y coordinate values of the feature points at lower left and lower right (step S204). The mark search unit 2012 determines whether the difference between each pair of the two compared coordinate values is less than or equal to a threshold (step S205).

For example, the coordinate value of the upper left feature point is represented by (X_upper_left, Y_upper_left), the coordinate value of the lower left feature point is represented by (X_lower_left, Y_lower_left), the coordinate value of the upper right feature point is represented by (X_upper_right, Y_upper_right), and the coordinate value of the lower right feature point is represented by (X_lower_right, Y_lower_right). The mark search unit 2012 determines whether the following equations 1 and 2 are satisfied (step S205).

|Y_upper_left−Y_upper_right|≤th_y Equation 1

|Y_lower_left−Y_lower_right|≤th_y Equation 2

Note that the “th_y” is a threshold in the Y coordinate value.

When the mark search unit 2012 determines that the difference between the two compared coordinate values of any one pair is greater than the threshold (NO in step S205), the mark search unit 2012 determines that no mark is present (step S209), and then the mark searching process ends.

Next, when the mark search unit 2012 determines that the difference between the two compared coordinate values of each pair is less than or equal to the threshold (YES in step S205), the mark search unit 2012 compares the X coordinate values of the feature points at the upper left and lower left and compares the X coordinate values of the feature points at upper right and lower right (step S206). The mark search unit 2012 determines whether the difference between the two compared coordinate values of each pair is less than or equal to a threshold (step S207).

Specifically, the mark search unit 2012 determines whether the following equations 3 and 4 are satisfied.

|X_upper_left−X_lower_left|≤th_x Equation 3

|X_upper_right−X_lowerright|≤th_x Equation 4

Note that the “th_x” is a threshold in the X coordinate value.

When the mark search unit 2012 determines that the difference between the two compared coordinate values of any one pair is greater than the threshold (NO in step S207), the mark search unit 2012 determines that no mark is present (step S209), and then the mark searching process ends.

Next, when the mark search unit 2012 determines that the difference between the compared two coordinate values of each pair is less than or equal to the threshold (YES in step S207), the mark search unit 2012 determines that a mark is present (step S208).

As described above, the mark search unit 2012 determines the validity of whether the detected feature points are appropriately detected from the corners of the mark by the series of processing in steps S204 to S207 of the mark searching process. Since the mark is used for cutting, it is considered that the main scanning positions and the sub-scanning positions of the corners of the mark included in the master image data substantially match. As a result, the mark search unit 2012 may determine the validity based on the feature of the mark by the above-described processing.

FIG. 8 is a first diagram illustrating an example of the mark.

In FIG. 8, a master image 400 includes a trimming mark 401 together with a user image 403 designated by a user. The trimming mark 401 is used for cutting or alignment. As illustrated in FIG. 8, the trimming mark 401 has corners at four corner positions near edges 402 of the master image 400. The term “corner” used herein represents an area where a large change in pixel value is observed in each direction.

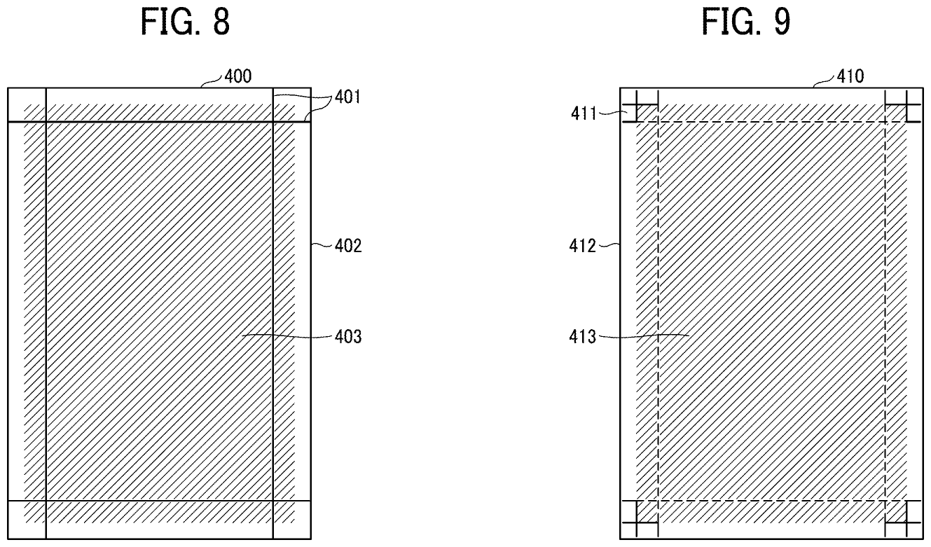

FIG. 9 is a second diagram illustrating an example of the mark.

In FIG. 9, a master image 410 includes a corner mark 411 together with a user image 413. The corner mark 411 is used for cutting or alignment in the same manner as the trimming mark 401. As illustrated in FIG. 9, like the trimming mark 401, the corner mark 411 has corners at four corner positions near edges 412 of the master image 410.

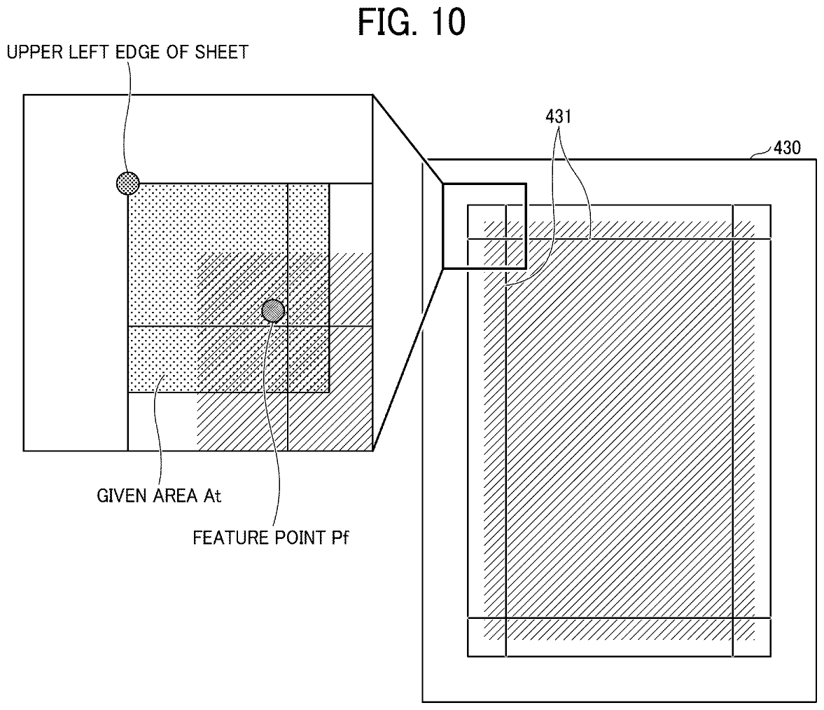

FIG. 10 is a diagram illustrating a mark searching method according to embodiments of the present disclosure.

In step S202 of the mark searching process, the mark search unit 2012 detects the feature points in the given areas from the sheet edges in the master image. Specifically, for example, the mark search unit 2012 performs corner detection and detects a feature point (feature point Pf) in an area (given area At) having a constant length from the upper left edge of the sheet. The mark search unit 2012 may employ, for example, a Harris operator as a corner detection method (algorithm).

Since the mark such as a trimming mark 431 is generally printed on an end portion of the sheet, the mark search unit 2012 selects the feature points closest to the upper left, lower left, upper right, and lower right edges of the sheet from the feature points detected by the corner detection.

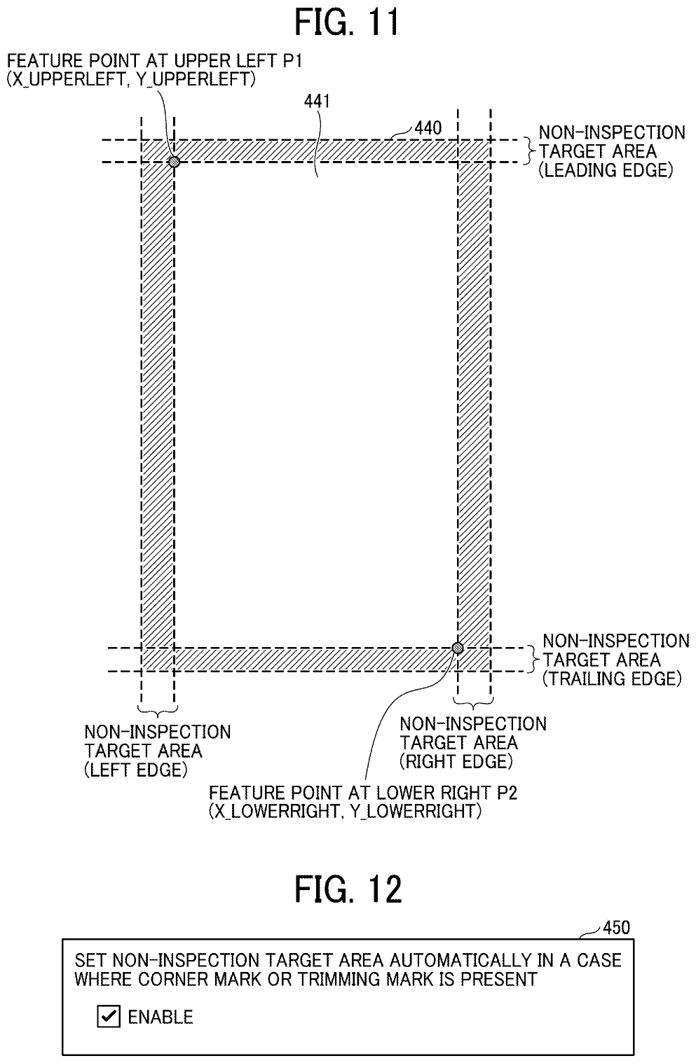

FIG. 11 is a diagram illustrating a determination method of a non-inspection-target area according to embodiments of the present disclosure. The non-inspection-target area determination unit 2014 determines an area to be cut as a non-inspection-target area based on the mark position calculated in the master image 440. The non-inspection-target area determination unit 2014 uses the coordinate values (X_upperLeft, Y_upperLeft) of an upper left feature point P1 and the coordinate values (X_lowerRight, Y_lowerRight) of a lower right feature point P2.

The non-inspection-target area determination unit 2014 determines that the non-inspection-target area at the leading edge of a page is in a range from the y coordinate value (Y_upperLeft) of the feature point P1 to the leading edge of the sheet. In addition, the non-inspection-target area determination unit 2014 determines that the non-inspection-target area at the trailing edge of the page is in a range from the y coordinate value (Y_lowerRight) of the feature point P2 to the trailing edge of the sheet.

The non-inspection-target area determination unit 2014 determines that the non-inspection-target area at the left edge of the page is from the x coordinate value (X_upperLeft) of the feature point P1 to the left edge of the sheet. In addition, the non-inspection-target area determination unit 2014 determines that the non-inspection-target area at the right edge of the page is from the x coordinate value (X_lowerRight) of the feature point P2 to the right edge of the sheet.

In this case, an inspection-target area 441 excluding the non-inspection-target area has the following ranges in the main scanning direction and the sub-scanning direction. The inspection-target area in the main scanning direction is in a range from (X_upperLeft+1) to (X_lowerRight−1). The inspection-target area in the sub-scanning direction is in a range from (Y_upperLeft+1) to (Y_lowerRight−1).

FIG. 12 is a diagram illustrating an example of a setting screen according to embodiments of the present disclosure. A setting screen 450 is displayed on the operation panel 117. When a user checks a checkbox of the setting screen 450 to perform an operation for confirmation, the inspection device 20 stores the setting values. The inspection device executes the processing from step S102 to step S105 of the defect detection process illustrated in FIG. 6 in a case where the checkbox of the setting screen 450 is checked. In a case where the checkbox of the setting screen 450 is not checked, the inspection device 20 skips the processing from step S102 to step S105 of the defect detection process. In other words, the non-inspection-target area determination unit 2014 receives the setting for enabling the function of determining the non-inspection-target area. In a case where the setting indicates to enable the function, the non-inspection-target area determination unit 2014 executes the process of determining the non-inspection-target area.

According to the image forming system 1 of the present embodiment, a mark is searched based on master image data, and a non-inspection-target area is automatically determined based on the position of the searched mark. Such a configuration can reduce the effort of setting the non-inspection-target area.

Further, the image forming system 1 detects feature points included in given areas at four corners of each side (each surface) of a sheet. Then the image forming system 1 searches for the feature points as the mark when the feature points are detected at the four corners. Accordingly, when the user image includes an image representing a shape such as a table, an error of recognizing the image as a mark can be prevented.

Further, the image forming system 1 determines whether the mark is present based on the horizontal or vertical position of each of the feature points detected at the four corners. Due to such a configuration described above, the feature of the corner mark or the trimming mark can be captured, and the mark can be more accurately detected.

In each of the above-described embodiments, the DFE 30, the inspection device 20, and the printer 10 may be configured to share the above-described processing steps in various combinations. Further, the elements of the DFE 30, the inspection device 20, and the printer may be integrated into one apparatus or may be separately disposed in a plurality of different apparatuses.

In an embodiment, the DFE 30 or the inspection device 20 may be configured as an information processing system including a plurality of computing devices such as a server cluster. The plurality of computing devices are configured to communicate with one another via any type of communication link, including a network or shared memory to implement the processing described in the present specification.

Each of the functions of the above-described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The elements of the above-described embodiments can be modified without departing from the gist of the present invention, and can be appropriately determined according to the application form.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. An inspection device comprising:
processing circuitry configured to:
search for a mark included in master image data generated based on an image to be printed; and
determine a non-inspection-target area to be excluded from an inspection-target area in a conveyance medium on which the image is printed, based on a position of the searched mark.

2. The inspection device according to claim 1,
wherein the processing circuitry is configured to search for the mark for each page included in print job data, and
wherein the processing circuitry is configured to determine the non-inspection-target area for each page included in print job data.

3. The inspection device according to claim 1, further comprising processing circuitry configured to calculate the position of the searched mark based on information of the conveyance medium,
wherein the processing circuitry is configured to determine an area between an edge of the conveyance medium and the position of the mark as the non-inspection-target area based on the calculated position of the searched mark.

4. The inspection device according to claim 1,
wherein the processing circuitry is configured to:
receive a setting for enabling a function of determining the non-inspection-target area; and
execute a process of determining the non-inspection-target area in a case where the function is enabled by the setting.

5. The inspection device according to claim 1,
wherein the processing circuitry is configured to detect feature points included in given areas at four corners of each side of the conveyance medium, and
wherein the processing circuitry is configured to search for the feature points as the mark in a case where the feature points are detected at the four corners.

6. The inspection device according to claim 5,
wherein the processing circuitry is configured to determine whether the mark is present based on a horizontal or vertical position of each of the feature points detected at the four corners.

7. A computer-executable method of determining a non-inspection-target area, the method comprising:
searching for a mark included in master image data generated based on an image to be printed; and
determining a non-inspection-target area to be excluded from an inspection-target area in a conveyance medium on which the image is printed, based on a position of the searched mark.

8. A non-transitory, computer-readable storage medium storing computer-readable program code that causes a computer to perform:
searching for a mark included in master image data generated based on an image to be printed; and
determining a non-inspection-target area to be excluded from an inspection-target area in a conveyance medium on which the image is printed, based on a position of the searched mark.
